(19) United States
(12) Patent Application Publication
(10) Pub. No.: US 2024/0202578 A1
(43) Pub. Date: Jun. 20, 2024

(54) PHASE-BASED MACHINE LEARNING AND USER INTERFACES FOR THE SAME

(71) Applicant: Accenture Global Solutions Limited, Dublin (IE)

(72) Inventors: Mahesh ZURALE, Pune (IN); Aditi KULKARNI, Bangalore (IN); Koushik M. VIJAYARAGHAVAN, Chennai (IN); Seshadri BHAGAWATGEETA, Thane West (IN); Jana KOUSTUV, Bangalore (IN); Srinivasan KOOTALAI SUNDARAM, Tamil Nadu (IN); Krishnaveni AYYAPPAN, Medavakkam (IN); Harish KUMAR GUPTA, Uttar Pradesh (IN); Arulvasu Ramaswamy VYRAVAN, Chennai (IN); Kanwal HANS, Delhi (IN); Sridevi VINEET MEHTA, Bangalore (IN); Lakshmi SUTHANTHIRANATHAN, Bangalore (IN); Anuj KUMAR TALWAR, Bangalore (IN); Vaishali PANDIT, Maharashtra (IN)

(21) Appl. No.: 18/082,067

(22) Filed: Dec. 15, 2022

(51) Int. Cl. G06N 20/00; G06N 7/01

(52) U.S. Cl. CPC G06N 20/00; G06N 7/01

(57) ABSTRACT

In some implementations, a planning system may receive multiple files in multiple formats and associated with historical contracting information. The planning system may convert the plurality of files into a unified data format, to generate a unified set of data, and may update a machine learning model based on the unified set of data. The planning system may receive input associated with a current contract and may select a set of factors based on a phase associated with the current contract. The planning system may apply the machine learning model to the input to generate a probability associated with the current contract and may provide instructions for a user interface that visually depicts the probability. The planning system may additionally generate recommended modifications to increase the probability. The recommended modifications may be fed back into a training (and retraining) cycle for the machine learning model to increase accuracy.

### BACKGROUND

Planning for a current contract usually includes numerous rounds of revision in order to develop a proposal and accompanying documents. Typically, these rounds of revision are performed using computing devices and therefore cost power and processing resources. Additionally, these rounds of revision may be performed across sectors of an organization and therefore cost networking resources.

### SUMMARY

Some implementations described herein relate to a method. The method may include receiving, from a plurality of data sources, a plurality of files in a plurality of formats and associated with historical contracting information. The method may include converting the plurality of files into a unified data format, to generate a unified set of data, using one or more scripts. The method may include updating a machine learning model based on the unified set of data. The method may include receiving input associated with a current contract. The method may include selecting a set of factors, from a plurality of sets of factors, based on a phase associated with the current contract. The method may include applying the machine learning model to the input to generate a probability associated with the current contract. The method may include providing instructions for a user interface (UI) that visually depicts the probability.

Some implementations described herein relate to a device. The device may include one or more memories and one or more processors communicatively coupled to the one or more memories. The one or more processors may be configured to receive, from a plurality of data sources, a plurality of files in a plurality of formats and associated with historical contracting information. The one or more processors may be configured to convert the plurality of files into a unified data format, to generate a unified set of data, using one or more scripts. The one or more processors may be configured to update a machine learning model based on the unified set of data. The one or more processors may be configured to receive input associated with a current contract. The one or more processors may be configured to select a set of factors, from a plurality of sets of factors, based on a phase associated with the current contract. The one or more processors may be configured to apply the machine learning model, based on the selected set of factors, to the input to generate a probability associated with the current contract. The one or more processors may be configured to generate one or more modifications to the input based on the probability failing to satisfy a threshold. The one or more processors may be configured to transmit, to a user device, one or more files encoding the one or more modifications.

Some implementations described herein relate to a non-transitory computer-readable medium that stores a set of instructions for a device. The set of instructions, when executed by one or more processors of the device, may cause the device to receive, from a plurality of data sources, a plurality of files in a plurality of formats and associated with historical contracting information. The set of instructions, when executed by one or more processors of the device, may cause the device to convert the plurality of files into a unified data format, to generate a unified set of data, using one or more scripts. The set of instructions, when executed by one or more processors of the device, may cause the device to update a machine learning model based on the unified set of data. The set of instructions, when executed by one or more processors of the device, may cause the device to receive input associated with a current contract. The set of instructions, when executed by one or more processors of the device, may cause the device to apply the machine learning model to the input to generate one or more recommended parameters for the current contract. The set of instructions, when executed by one or more processors of the device, may cause the device to provide instructions for a UI that visually depicts the one or more recommended parameters. The set of instructions, when executed by one or more processors of the device, may cause the device to transmit one or more files encoding the one or more recommended parameters.

### BRIEF DESCRIPTION OF THE DRAWINGS

FIGS. 1A-1H are diagrams of an example implementation described herein.

FIGS. 2A-2C are diagrams of example user interfaces described herein.

FIG. 3 is a diagram of an example environment in which systems and/or methods described herein may be implemented.

FIG. 4 is a diagram of example components of one or more devices of FIG. 3.

FIG. 5 is a flowchart of an example process relating to phase-based machine learning.

### DETAILED DESCRIPTION

The following detailed description of example implementations refers to the accompanying drawings. The same reference numbers in different drawings may identify the same or similar elements.

In order to prepare a bid for a contract, users may engage in numerous rounds of revision in order to develop a proposal and accompanying documents. Because the users develop the proposal and accompanying documents using computing devices, the rounds of revision cost power and processing resources. Additionally, the users may be distributed across multiple sectors of an organization. As a result, the rounds of revision may further cost network resources.

Using machine learning to predict a probability associated with the bid can help reduce how many rounds of revision are performed. Additionally, machine learning may be used to recommend modifications in order to further reduce how many rounds of revision are performed. Some implementations described herein enable multiple data formats to be unified in order to increase an accuracy of a machine learning model applied to a bid for a contract. As a result, the machine learning model may recommend more accurate modifications to the bid in order to further reduce how many rounds of revision are performed. Engaging in fewer rounds of revision conserves power, processing resources, and network resources.

Additionally, or alternatively, some implementations described herein enable different factors to be used by a machine learning model, applied to a bid for a contract, based on a phase associated with the contract (e.g., a planning phase, a constructing phase, or a finalization phase) in order to increase an accuracy of the machine learning model. As a result, the machine learning model may recommend more accurate modifications to the bid in order to further reduce how many rounds of revision are performed, which in turn conserves power, processing resources, and network resources.

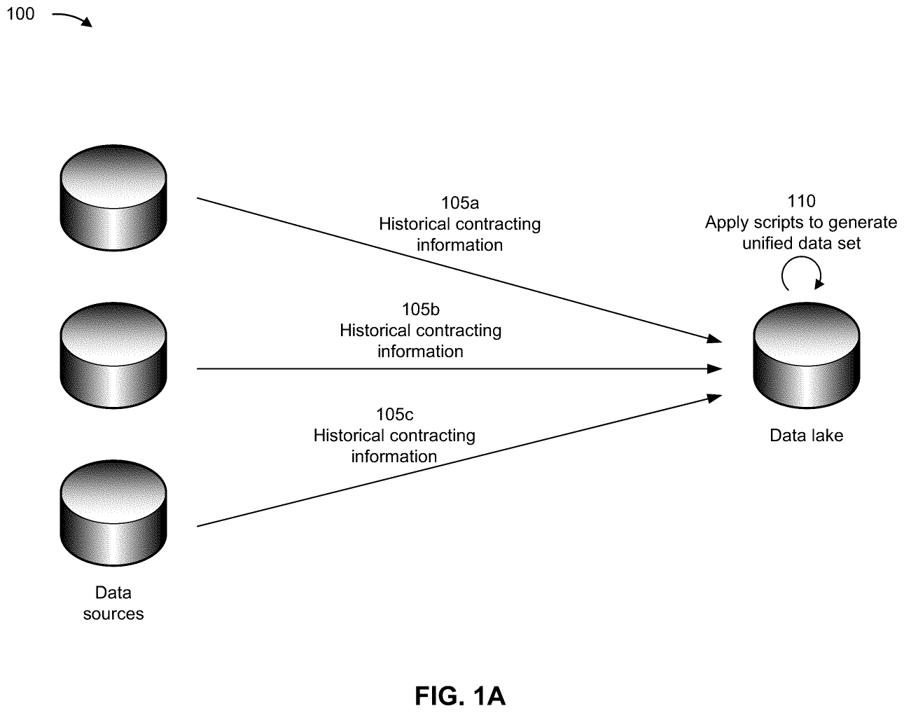

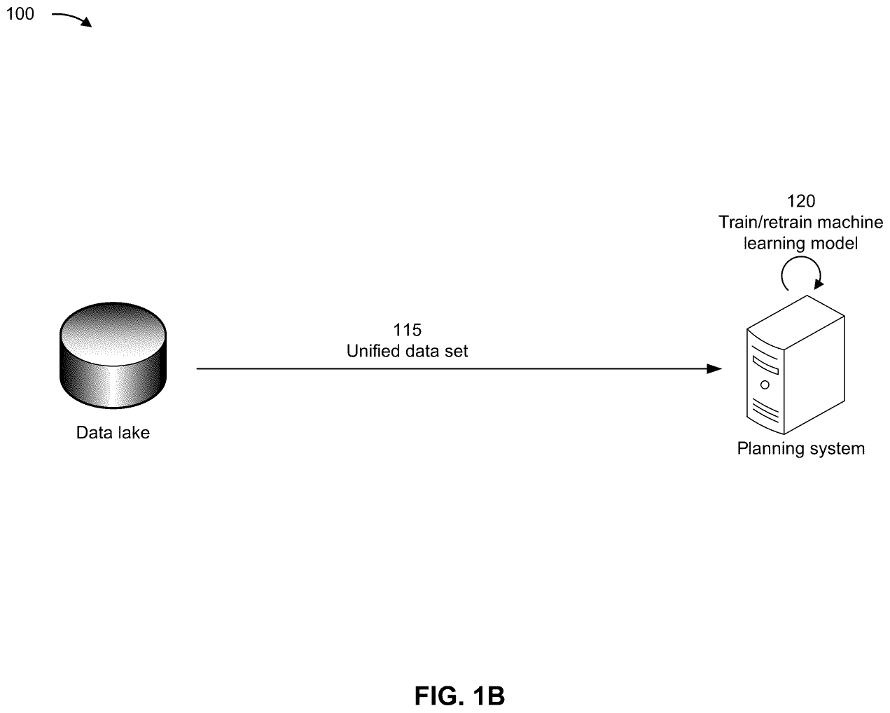

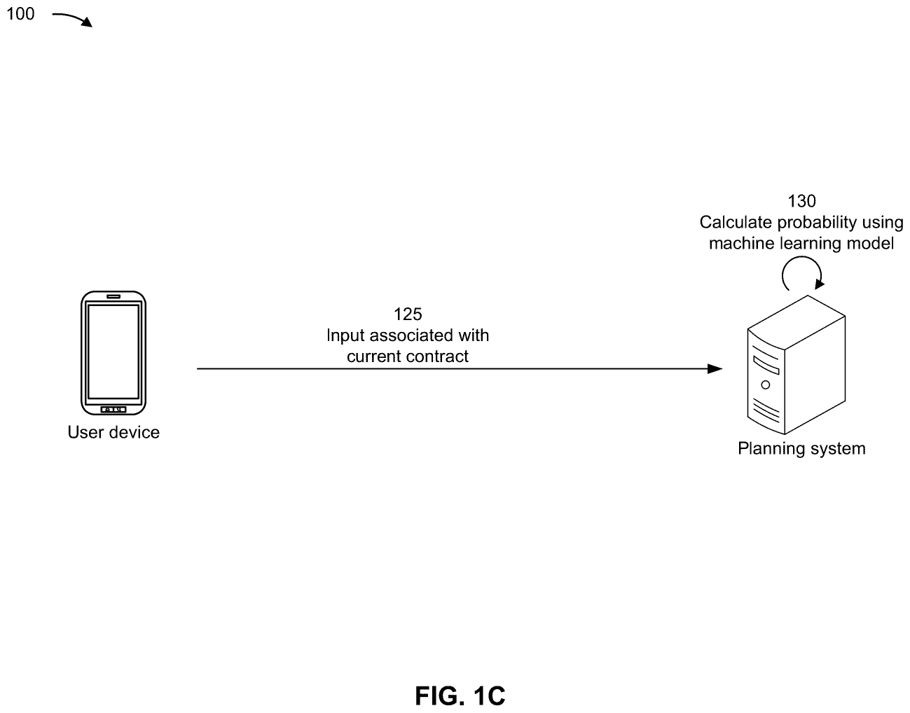

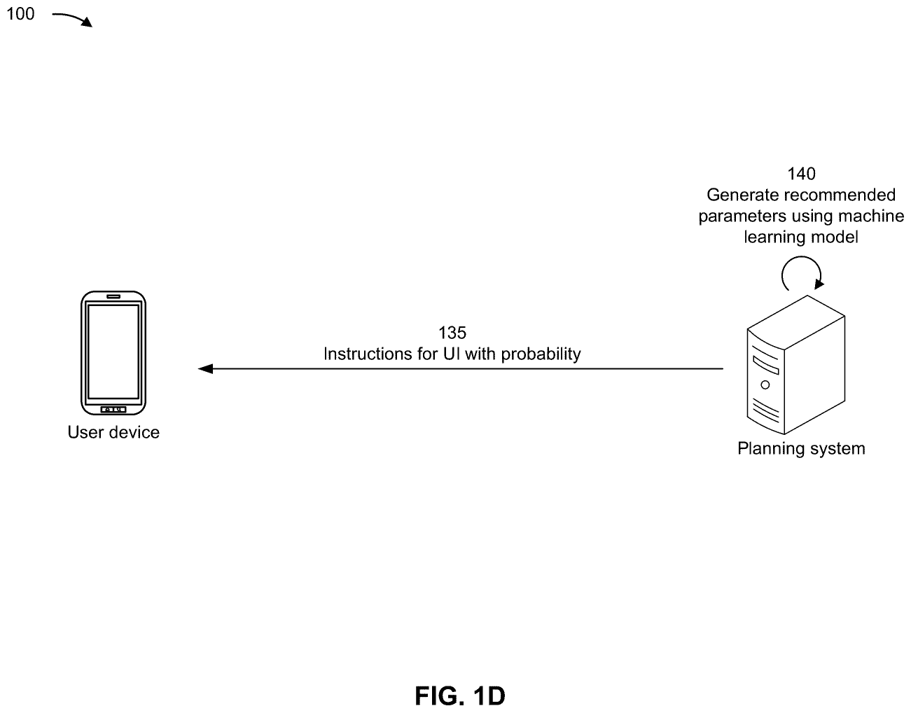

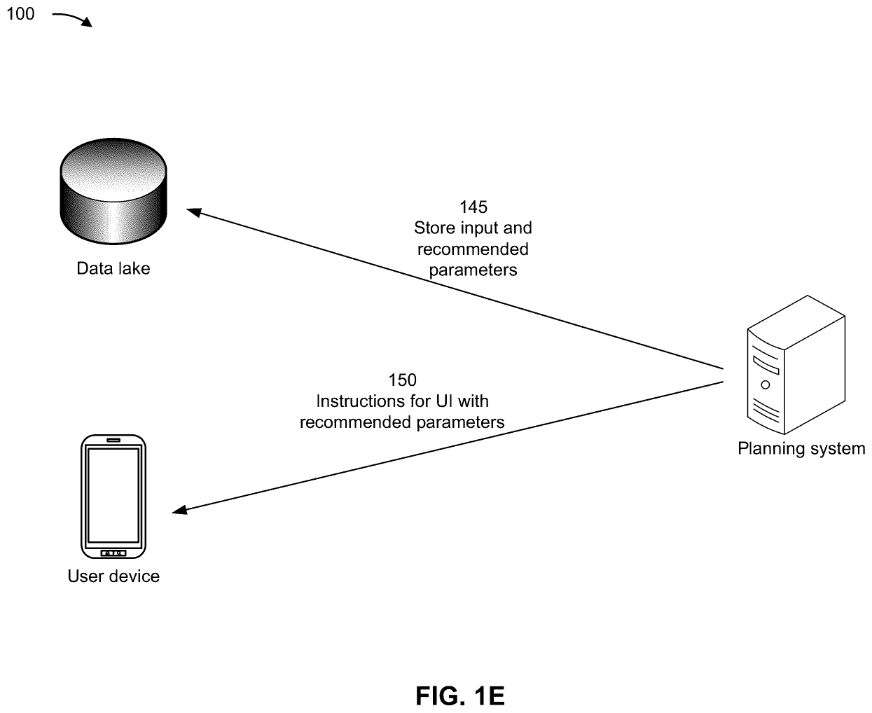

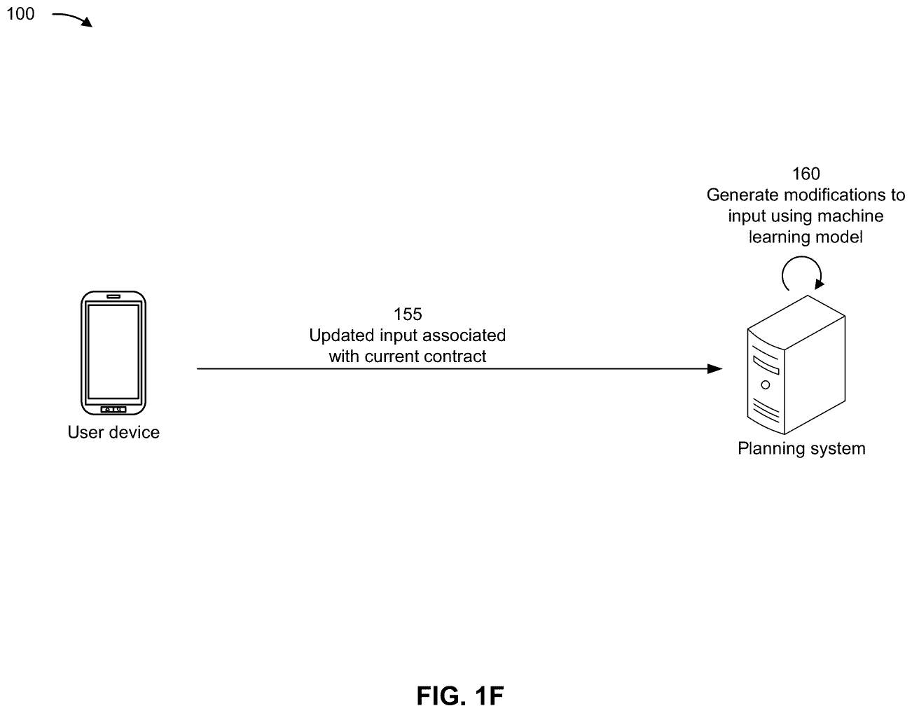

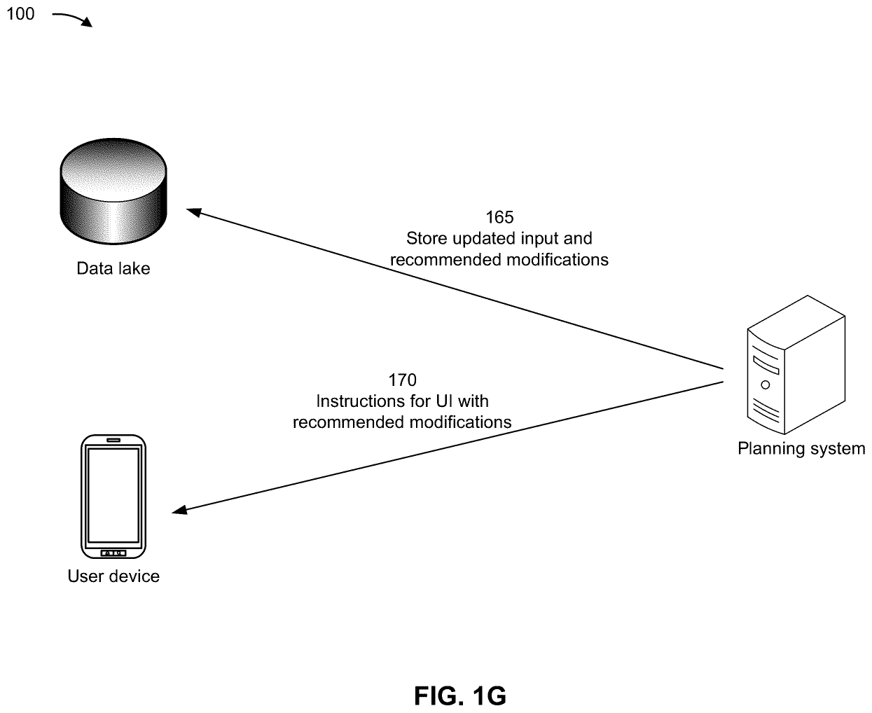

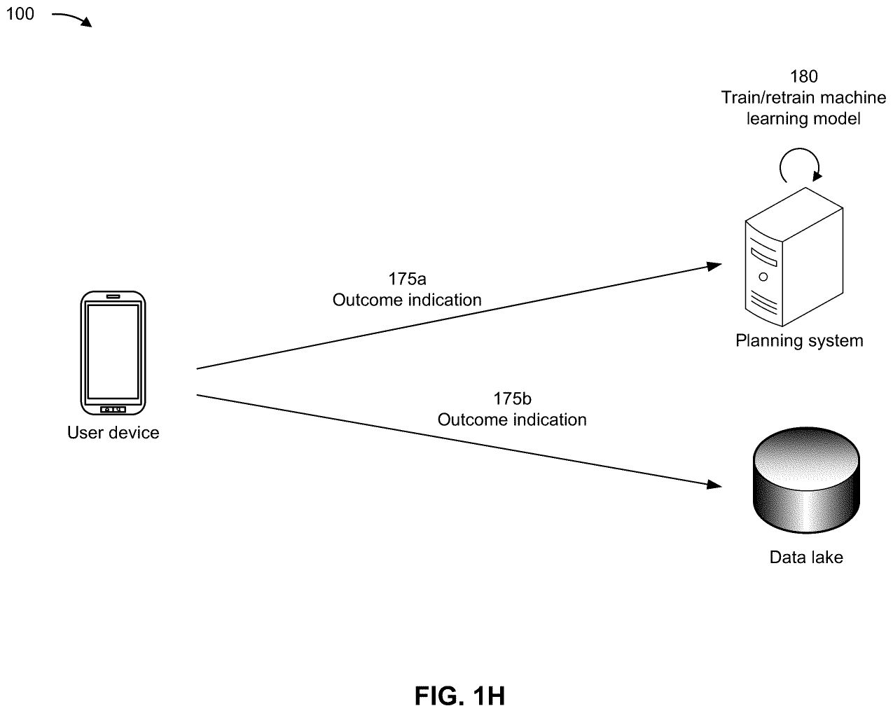

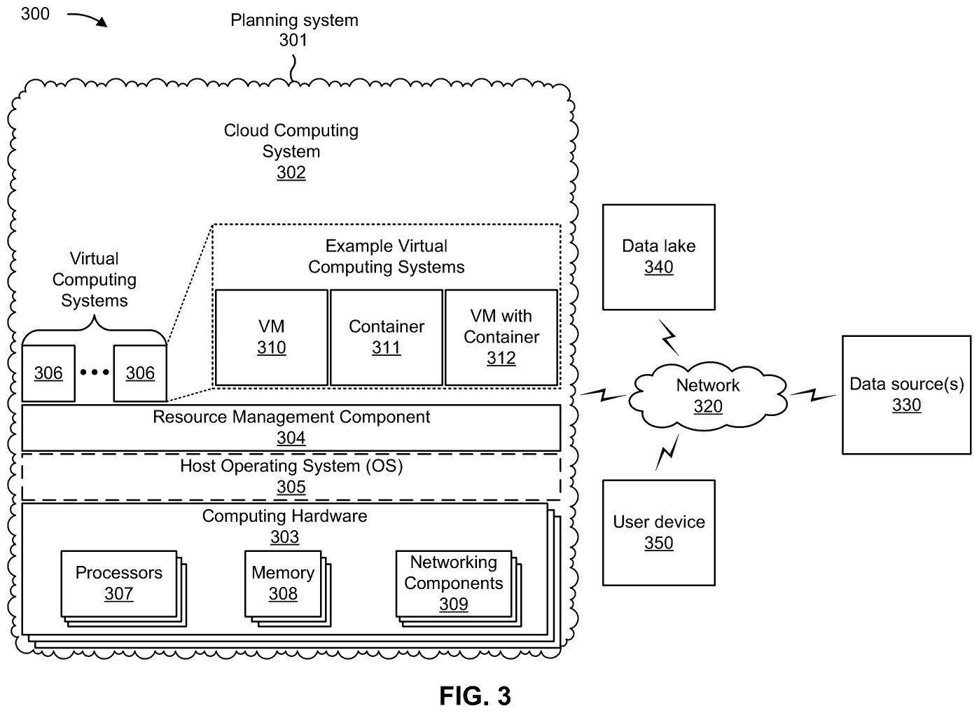

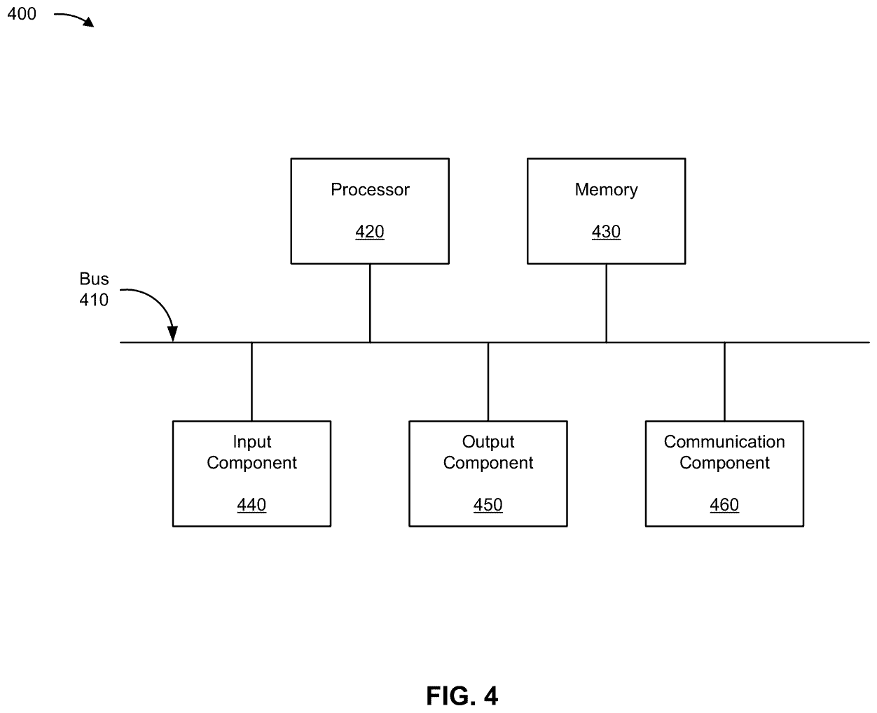

FIGS. 1A-1H are diagrams of an example implementation 100 associated with phase-based machine learning. As shown in FIGS. 1A-1H, example implementation 100 includes a planning system, a plurality of data sources, a data lake, and a user device. These devices are described in more detail below in connection with FIG. 3 and FIG. 4.

As shown in FIG. 1A and by reference numbers 105a, 105b, and 105c, the data sources may transmit, and the data lake may receive, multiple files associated with historical contracting information. For example, the files may encode submitted bids (e.g., from an initial draft until a final submission) as well as whether the submitted bids were accepted. By harvesting the files from multiple data sources, the data lake may improve accuracy of a machine learning model trained and used by the planning system (e.g., as described in connection with FIG. 1B). The files may be in a plurality of formats. For example, the formats may include an application outsourcing (AO) format, a systems integration (SI) format, a strategy and consulting (S&C) format, an infrastructure outsourcing (IO) format, a business process outsourcing (BPO) format, and/or a spreadsheet (e.g., a Microsoft Excel®) format.

In some implementations, the data lake may use representational state transfer (REST) application programming interfaces (APIs) to obtain the files. For example, the data lake may transmit (e.g., periodically or upon request by the planning system) requests to the APIs and receive the files as responses to the requests. Alternatively, the data lake may subscribe to updates from the data sources, such that the APIs are triggered and transmit the files based on the files being generated at the data sources.

As shown by reference number 110, the data lake may apply scripts (e.g., one or more scripts) to the files in order to standardize information encoded in the files. The scripts may be written in Python or another type of scripting language. Using scripts (such as Python scripts) is faster than compiling and executing high-level code (e.g., C++ code or another type of high-level code) or assembly-level code. The scripts may convert the files into a unified data format. For example, the scripts may extract the information encoded in the files and store the extracted information in a structured query language (SQL) format or another type of database format.

Accordingly, the data lake converts the files into a unified set of data. For example, the unified set of data may have a common schema (e.g., defined in SQL or another database format, whether tabular, graphical, or another organizational structure). Additionally, in some implementations, the data lake may generate metadata associated with each file and store the metadata. For example, the metadata associated with a file may include a name of the file, a creation datetime for the file, a size of the file, and/or an indication of a source for the file, among other examples. As used herein, “datetime” refers to a data structure that encodes a date or a combination of a date and a time.

As shown in FIG. 1B and by reference number 115, the data lake may transmit, and the planning system may receive, the unified set of data. As described above, the set of data may be associated with historical contracting information. In some implementations, the data lake may transmit the unified set of data whenever new files are received and converted, as described above. Alternatively, the data lake may transmit the unified set of data periodically (e.g., according to a default schedule or a schedule indicated by the planning system). Alternatively, the planning system may transmit, and the data lake may receive, a request for updated information; therefore, the data lake may transmit the unified set of data in response to the request.

As shown by reference number 120, the planning system may train (or retrain) a machine learning model based on the unified set of data. The machine learning model may be trained to accept information about a bid as input (e.g., the information described in connection with FIG. 1C) and to output a probability associated with the bid (e.g., a probability of winning the bid). Additionally, the machine learning model may output recommended parameters for the bid. In some implementations, the update may include a retraining of the machine learning model using the unified set of data.

In some implementations, the machine learning model comprises a multi-class neural network. For example, the multi-class neural network may achieve a higher accuracy than a random forest model or a logistic regression model. As a result, the multi-class neural network may recommend better parameters for the bid and thus conserve power, processing resources, and network resources that would otherwise be spent on additional rounds of revision of the bid.

Training (and retraining) the machine learning model may include exploratory data analysis. For example, the planning system may convert the unified set of data to a set of feature values and may generate a report indicating the feature values associated with the unified set of data. The feature values may therefore be associated with a plurality of dimensions (also known as “features”). As a result, the planning system may determine a coefficient of variation associated with each dimension. The planning system may additionally generate scatter plots to determine which dimensions are correlated with bid outcome. The planning system may infer values for missing feature values from the unified set of data or generate replacement values (e.g., using a generative-adversarial network) for missing feature values.

In some implementations, the planning system may reduce a number of dimensions by using principal components analysis, p-value hypothesis testing, classifier scores, or another type of dimensionality reduction. Accordingly, the planning system may select relevant features and discard irrelevant features.

The planning system may transform financial features into bins (also referred to as “buckets”). Additionally, or alternatively, competitor features may be encoded by column, where each column is associated with a unique competitor name. The planning system may apply leave-one-out encoding or another higher-dimension encoding scheme in order to preserve more data patterns as compared with one-hot encoding and other lower-dimension encoding schemes. As a result, the machine learning model may recommend better parameters for the bid and thus conserve power, processing resources, and network resources that would otherwise be spent on additional rounds of revision of the bid.

The planning system may perform training and testing using the unified set of data. For example, 75% of the set of data may be used for training, and 25% for testing. Accordingly, the planning system may tune hyperparameters while reducing a loss function during training and testing. The machine learning model may be deployed in a cloud environment (e.g., as described in connection with FIG. 3). The deployment may be containerized in order to increase speed and security, as compared to a centralized deployment.

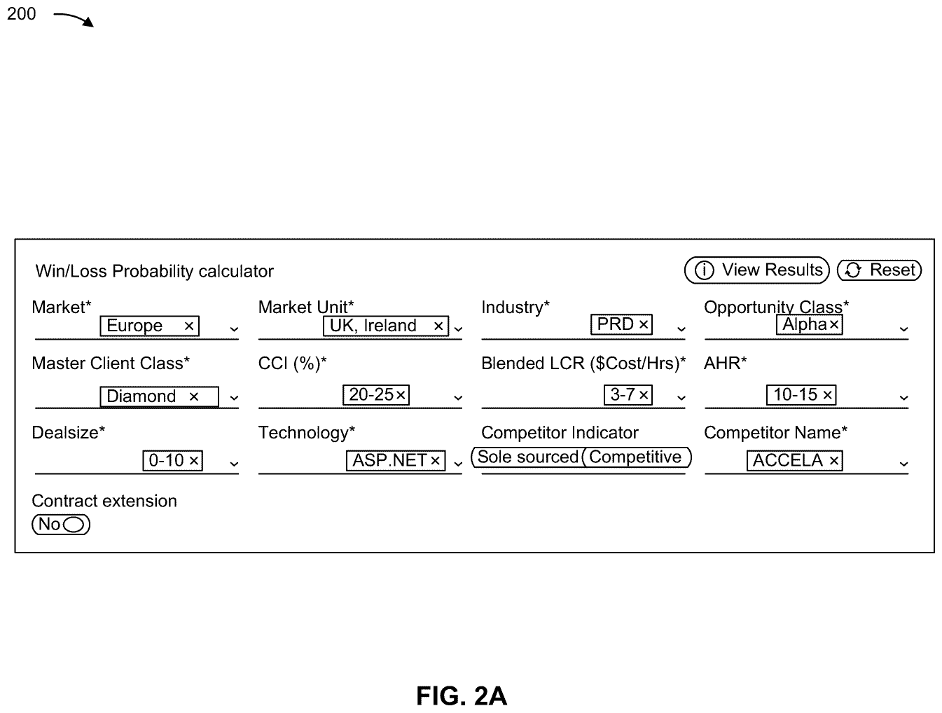

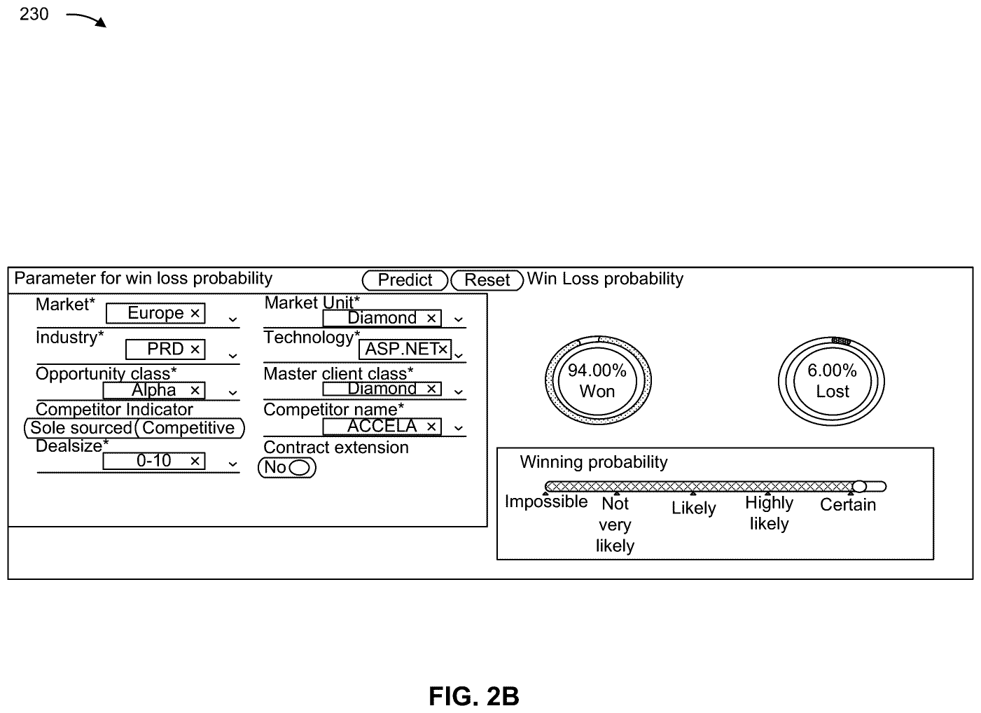

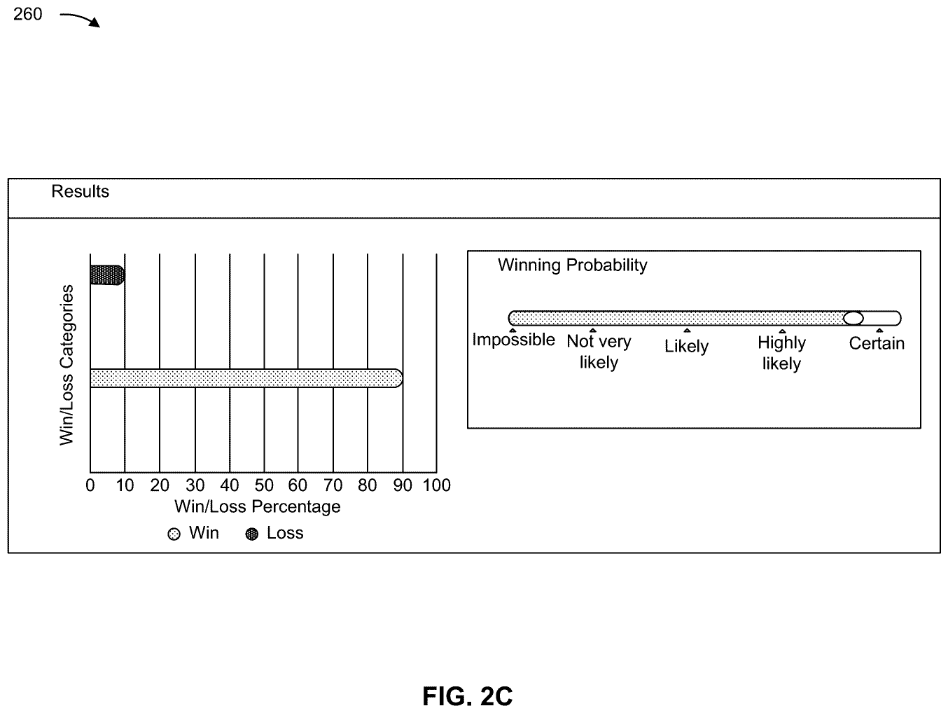

As shown in FIG. 1C and by reference number 125, the user device may transmit, and the planning system may receive, input associated with a current contract. The user device may receive the input from a user with a user interface (UI) as described in connection with FIG. 2A or FIG. 2B. In some implementations, the current contract may be in a planning phase. Accordingly, the input may indicate a market area, a market unit, an industry segment, a responsible business entity, a client group, a competitor, a deal size, a client name, a technology, a contract extension, an opportunity class, and/or a master client class, among other examples. Alternatively, the current contract may be in a constructing phase. Accordingly, the input may indicate a market area, a market unit, a client group, a competitor, a contract extension, an opportunity class, a master client class, an onshore-offshore staffing mix, price or cost metrics, and/or a run rate productivity, among other examples. Alternatively, the current contract may be in a finalization phase. Accordingly, the input may indicate a market area, a market unit, an industry segment, a responsible business entity, a client group, a competitor, a client name, a technology, a contract extension, an opportunity class, a master client class, a contract controllable income, a blended liquidity coverage ratio, a price per hour, a deal size, a deal duration, a service delivery effort, and/or an offshore ratio, among other examples.

As shown by reference number 130, the planning system may apply the machine learning model to the input to generate a probability associated with the current contract. For example, the machine learning model may predict a chance of winning the current contract based on the input. In some implementations, the planning system may apply the machine learning model to different factors based on the phase associated with the current contract. Accordingly, as described above, the input may be different depending on the phase. By selecting different sets of factors based on different phases associated with the current contract, accuracy of the machine learning model is improved as compared with using a single phase-independent set of factors.

As shown in FIG. 1D and by reference number 135, the planning system may provide, and the user device may receive, instructions for a UI that visually depicts the probability. For example, the user device may display a UI as described in connection with FIG. 2B or FIG. 2C. Accordingly, the UI may include a pie chart and/or a bar graph depicting the probability.

Additionally, as shown by reference number 140, the planning system may generate recommended parameters (e.g., one or more recommended parameters) for the current contract. For example, the planning system may apply the machine learning model to generate the recommended parameters. In one example, the input may indicate a market area of North America, a market unit of Mid-west America, and an industry segment of healthcare. Accordingly, the machine learning model may generate a recommended staffing demand (e.g., per county and/or per city), a recommended billing rate, a recommended average cost, a recommended technology to apply, and/or a recommended productivity plan. Similarly as for the probability, the planning system may apply the machine learning model to different factors based on the phase associated with the current contract. By selecting different sets of factors based on different phases associated with the current contract, accuracy of the machine learning model is improved as compared with using a single set of factors. Therefore, the machine learning model may generate better recommended parameters and thus conserve power, processing resources, and network resources that would otherwise be spent on additional rounds of revision associated with the current contract.

In some implementations, the planning system may generate the recommended parameters as initial parameters for the current contract. Alternatively, the probability described above may fail to satisfy a threshold (e.g., the probability represents a chance of winning the current contract below 50%). Accordingly, the planning system may trigger generation of the recommended parameters in response to the probability failing to satisfying the threshold. By automatically generating the recommended parameters that are expected to increase the probability, the planning system conserves power, processing resources, and network resources that would otherwise be spent on additional rounds of revision associated with the current contract.

As shown in FIG. 1E and by reference number 145, the planning system may store the input and the recommended parameters in the data lake (or another storage associated with the machine learning model). Accordingly, the recommended parameters may be fed back into a training (and retraining) cycle for the machine learning model (e.g., as described above). The input and the recommended parameters may be stored in association with a first version indicator. As a result, the planning system may implement version control as the bid associated with the current contract is updated, as described below.

In some implementations, as shown by reference number 150, the planning system may provide, and the user device may receive, instructions for a UI that visually depicts the recommended parameters. Additionally, or alternatively, the planning system may input the recommended parameters to a web-based graph generator. For example, the web-based graph generator may include Microsoft Power BIR or another web-based interactive graphing service. Additionally, or alternatively, the planning system may transmit, and the user device may receive, files (e.g., one or more files) encoding the recommended parameters. The files may include a presentation file (e.g., a Microsoft PowerPoint® file) and/or a portable document format (pdf) file (e.g., an Adobe Acrobat® file), among other examples. The planning system may use template files and input the recommended parameters into fields of the template files. Additionally, or alternatively, the input from the user device may include files, and the planning system may modify the files to encode the recommended parameters.

The user may update the bid associated with the current contract (e.g., with new parameters based on the recommended parameters from the planning system and/or with a new phase because the current contract has progressed). Accordingly, as shown in FIG. 1F and by reference number 155, the user device may transmit, and the planning system may receive, updated input associated with the current contract. The user device may receive the input from a user with a UI as described in connection with FIG. 2A or FIG. 2B.

As shown by reference number 160, the planning system may generate recommended modifications (e.g., one or more modifications) for the current contract. For example, the planning system may apply the machine learning model to generate the recommended modifications. The planning system may apply the machine learning model to different factors based on the phase associated with the current contract. By selecting different sets of factors based on different phases associated with the current contract, accuracy of the machine learning model is improved as compared with using a single set of factors. Therefore, the machine learning model may generate better recommended modifications and thus conserve power, processing resources, and network resources that would otherwise be spent on additional rounds of revision associated with the current contract.

In some implementations, the planning system may determine a new probability based on the updated input. When the new probability fails to satisfy a threshold, the planning system may trigger generation of the recommended modifications in response to the probability failing to satisfy the threshold. By automatically generating the recommended modifications that are expected to increase the probability, the planning system conserves power, processing resources, and network resources that would otherwise be spent on additional rounds of revision associated with the current contract.

As shown in FIG. 1G and by reference number 165, the planning system may store the updated input and the recommended modifications in the data lake (or another storage associated with the machine learning model). Accordingly, the recommended modifications may be fed back into a training (and retraining) cycle for the machine learning model (e.g., as described above). The input and the recommended modifications may be stored in association with a second version indicator. As a result, the planning system may implement version control as the bid associated with the current contract is further updated.

In some implementations, as shown by reference number 170, the planning system may provide, and the user device may receive, instructions for a UI that visually depicts the recommended modifications. Additionally, or alternatively, the planning system may input the recommended modifications to a web-based graph generator. Additionally, or alternatively, the planning system may transmit, and the user device may receive, files (e.g., one or more files) encoding the recommended modifications. The files may include a presentation file and/or a pdf file, among other examples. The planning system may use template files and input the recommended modifications into fields of the template files. Additionally, or alternatively, the updated input from the user device may include files, and the planning system may modify the files to encode the recommended modifications.

As shown in FIG. 1H and by reference number 175a, the user device may transmit, and the planning system may receive, an outcome indication associated with the current contract. For example, the user may indicate whether the bid was won or lost (e.g., after multiple rounds of prediction and modification using the planning system, as described above).

Additionally, as shown by reference number 175b, the user device may store the outcome indication in the data lake. Alternatively, the planning system may store the outcome indication in the data lake. Accordingly, the outcome indication is fed back into a training (and retraining) cycle for the machine learning model (e.g., as described above), which continually increases accuracy for the machine learning model. For example, as shown by reference number 180, the planning system may train (or retrain) the machine learning model based on the outcome indication (and stored inputs and parameters associated with the current contract).

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

FIGS. 2A, 2B, and 2C are diagrams of example UIs 200, 230, and 260, respectively, associated with phase-based machine learning. Example UIs 200, 230, and 260 may be displayed on a user device based on instructions received from, and generated by, a planning system. These devices are described in more detail below in connection with FIG. 3 and FIG. 4.

As shown in FIG. 2A, the example UI 200 includes multiple input elements that accept input associated with a current contract. In FIG. 2A, the input elements include drop down menus and toggle switches. Other examples may additionally or alternatively include text boxes, checkboxes, and/or radio buttons, among other examples.

As shown in FIG. 2B, the example UI 230 includes multiple input elements that accept input associated with a current contract. In FIG. 2B, the input elements include drop down menus and toggle switches. Other examples may additionally or alternatively include text boxes, checkboxes, and/or radio buttons, among other examples. The example UI 230 further includes a bar graph and circles that show a probability associated with a current contract.

As shown in FIG. 2C, the example UI 260 similarly includes bar graphs that show a probability associated with a current contract. The example UI 260 shown in FIG. 2C may be used in a pop-up window rather than in a window integrated with the input elements as shown in FIG. 2B.

As indicated above, FIGS. 2A-2C are provided as examples. Other examples may differ from what is described with regard to FIGS. 2A-2C.

FIG. 3 is a diagram of an example environment 300 in which systems and/or methods described herein may be implemented. As shown in FIG. 3, environment 300 may include a planning system 301, which may include one or more elements of and/or may execute within a cloud computing system 302. The cloud computing system 302 may include one or more elements 303-312, as described in more detail below. As further shown in FIG. 3, environment 300 may include a network 320, one or more data sources 330, a data lake 340, and/or a user device 350. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the planning system 301 may include one or more elements 303-312 of the cloud computing system 302, may execute within the cloud computing system 302, and/or may be hosted within the cloud computing system 302, in some implementations, the planning system 301 may not be cloud-based (e.g., may be implemented outside of a cloud computing system) or may be partially cloud-based. For example, the planning system 301 may include one or more devices that are not part of the cloud computing system 302, such as device 400 of FIG. 4, which may include a standalone server or another type of computing device. The planning system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data source(s) 330 may include one or more devices capable of receiving, generating, storing, processing, and/or providing information associated with phase-based machine learning, as described elsewhere herein. The data source(s) 330 may include a communication device and/or a computing device. For example, the data source(s) 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source(s) 330 may communicate with one or more other devices of environment 300, as described elsewhere herein.

The data lake 340 may be implemented on one or more devices capable of receiving, generating, storing, processing, and/or providing information associated with phase-based machine learning, as described elsewhere herein. The data lake 340 may be implemented on a communication device and/or a computing device. For example, the data lake 340 may be implemented on a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data lake 340 may communicate with one or more other devices of environment 300, as described elsewhere herein.

The user device 350 may include one or more devices capable of receiving, generating, storing, processing, and/or providing information associated with a current contract, as described elsewhere herein. The user device 350 may include a communication device and/or a computing device. For example, the user device 350 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 350 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with phase-based machine learning. The device 400 may correspond to one or more data sources 330, a data lake 340, and/or a user device 350. In some implementations, the data source(s) 330, the data lake 340, and/or the user device 350 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

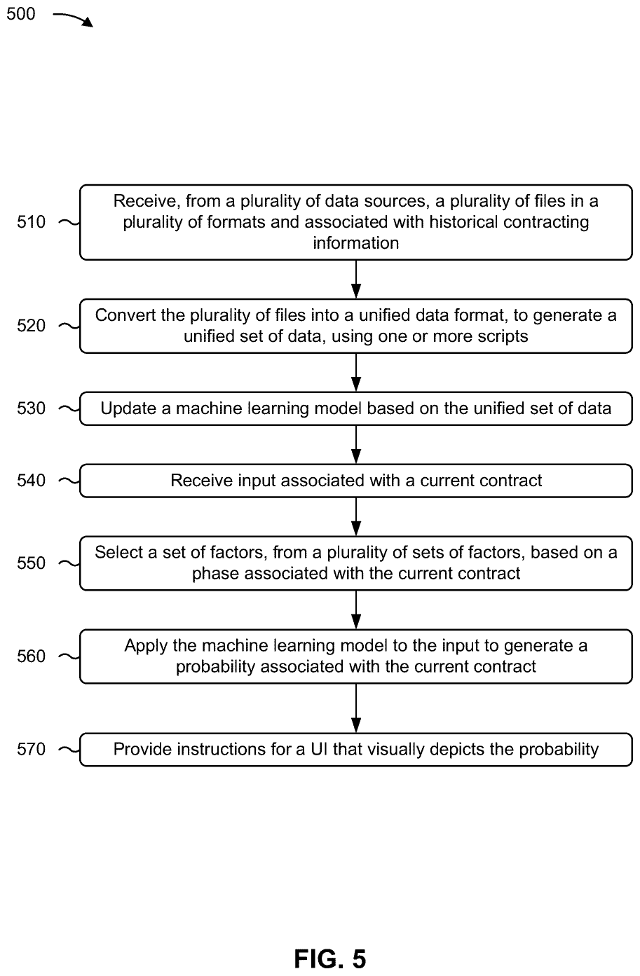

FIG. 5 is a flowchart of an example process 500 associated with phase-based machine learning. In some implementations, one or more process blocks of FIG. 5 are performed by a planning system (e.g., planning system 301). In some implementations, one or more process blocks of FIG. 5 are performed by another device or a group of devices separate from or including the planning system, such as one or more data sources (e.g., data source(s) 330), a data lake (e.g., data lake 340), and/or a user device (e.g., user device 350). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving, from a plurality of data sources, a plurality of files in a plurality of formats and associated with historical contracting information (block 510). For example, the planning system may receive, from a plurality of data sources, a plurality of files in a plurality of formats and associated with historical contracting information, as described herein.

As further shown in FIG. 5, process 500 may include converting the plurality of files into a unified data format, to generate a unified set of data, using one or more scripts (block 520). For example, the planning system may convert the plurality of files into a unified data format, to generate a unified set of data, using one or more scripts, as described herein.

As further shown in FIG. 5, process 500 may include updating a machine learning model based on the unified set of data (block 530). For example, the planning system may update a machine learning model based on the unified set of data, as described herein.

As further shown in FIG. 5, process 500 may include receiving input associated with a current contract (block 540). For example, the planning system may receive input associated with a current contract, as described herein.

As further shown in FIG. 5, process 500 may include selecting a set of factors, from a plurality of sets of factors, based on a phase associated with the current contract (block 550). For example, the planning system may select a set of factors, from a plurality of sets of factors, based on a phase associated with the current contract, as described herein.

As further shown in FIG. 5, process 500 may include applying the machine learning model to the input to generate a probability associated with the current contract (block 560). For example, the planning system may apply the machine learning model to the input to generate a probability associated with the current contract, as described herein.

As further shown in FIG. 5, process 500 may include providing instructions for a UI that visually depicts the probability (block 570). For example, the planning system may provide instructions for a UI that visually depicts the probability, as described herein.

Process 500 may include additional implementations, such as any single implementation or any combination of implementations described below and/or in connection with one or more other processes described elsewhere herein.

In a first implementation, the plurality of formats includes two or more of an application outsourcing format, a systems integration format, a strategy and consulting format, an infrastructure outsourcing format, a business process outsourcing format, or a spreadsheet format.

In a second implementation, alone or in combination with the first implementation, the one or more scripts include Python scripts that convert files to structured query language data.

In a third implementation, alone or in combination with one or more of the first and second implementations, updating the machine learning model includes performing a retraining using the unified set of data.

In a fourth implementation, alone or in combination with one or more of the first through third implementations, the machine learning model includes a multi-class neural network.

In a fifth implementation, alone or in combination with one or more of the first through fourth implementations, the phase associated with the current contract includes a planning phase, a constructing phase, or a finalization phase.

In a sixth implementation, alone or in combination with one or more of the first through fifth implementations, the UI includes a pie chart or a bar graph depicting the probability.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, from a plurality of data sources, a plurality of files in a plurality of formats and associated with historical contracting information;
converting the plurality of files into a unified data format, to generate a unified set of data, using one or more scripts;
updating a machine learning model based on the unified set of data;
receiving input associated with a current contract;
selecting a set of factors, from a plurality of sets of factors, based on a phase associated with the current contract;
applying the machine learning model to the input to generate a probability associated with the current contract; and
providing instructions for a user interface (UI) that visually depicts the probability.

2. The method of claim 1, wherein the plurality of formats includes two or more of an application outsourcing format, a systems integration format, a strategy and consulting format, an infrastructure outsourcing format, a business process outsourcing format, or a spreadsheet format.

3. The method of claim 1, wherein the one or more scripts comprise Python scripts that convert files to structured query language data.

4. The method of claim 1, wherein updating the machine learning model comprises:
performing a retraining using the unified set of data.

5. The method of claim 1, wherein the machine learning model comprises a multi-class neural network.

6. The method of claim 1, wherein the phase associated with the current contract comprises a planning phase, a constructing phase, or a finalization phase.

7. The method of claim 1, wherein the UI includes a pie chart or a bar graph depicting the probability.

8. A device, comprising:
one or more memories; and
one or more processors, communicatively coupled to the one or more memories, configured to:
receive, from a plurality of data sources, a plurality of files in a plurality of formats and associated with historical contracting information;
convert the plurality of files into a unified data format, to generate a unified set of data, using one or more scripts;
update a machine learning model based on the unified set of data;
receive input associated with a current contract;
select a set of factors, from a plurality of sets of factors, based on a phase associated with the current contract;
apply the machine learning model, based on the selected set of factors, to the input to generate a probability associated with the current contract;
generate one or more modifications to the input based on the probability failing to satisfy a threshold; and
transmit, to a user device, one or more files encoding the one or more modifications.

9. The device of claim 8, wherein the one or more processors are further configured to:
transmit the input associated with the current contract and the one or more modifications to a storage associated with the machine learning model.

10. The device of claim 8, wherein the one or more processors are further configured to:
store the one or more modifications in association with a first version indicator;
receive updated input associated with the current contract;
generate one or more new modifications to the updated input based on applying the machine learning model to the updated input; and
store the one or more new modifications in association with a second version indicator.

11. The device of claim 8, wherein the one or more processors, to generate the one or more modifications, are configured to:
apply the machine learning model to the input to receive the one or more modifications that are expected to increase the probability.

12. The device of claim 8, wherein the phase associated with the current contract comprises a planning phase, a constructing phase, or a finalization phase.

13. The device of claim 8, wherein the one or more files comprise a presentation file or a portable document format file.

14. A non-transitory computer-readable medium storing a set of instructions, the set of instructions comprising:
one or more instructions that, when executed by one or more processors of a device, cause the device to:
receive, from a plurality of data sources, a plurality of files in a plurality of formats and associated with historical contracting information;
convert the plurality of files into a unified data format, to generate a unified set of data, using one or more scripts;
update a machine learning model based on the unified set of data;
receive input associated with a current contract;
apply the machine learning model to the input to generate one or more recommended parameters for the current contract;
provide instructions for a user interface (UI) that visually depicts the one or more recommended parameters; and
transmit one or more files encoding the one or more recommended parameters.

15. The non-transitory computer-readable medium of claim 14, wherein the one or more instructions, when executed by the one or more processors, further cause the device to:
transmit the input associated with the current contract and the one or more recommended parameters to a storage associated with the machine learning model.

16. The non-transitory computer-readable medium of claim 14, wherein the one or more instructions, when executed by the one or more processors, further cause the device to:
select a set of factors, from a plurality of sets of factors, based on a phase associated with the current contract,
wherein the machine learning model is applied based on the selected set of factors.

17. The non-transitory computer-readable medium of claim 16, wherein the phase associated with the current contract comprises a planning phase, a constructing phase, or a finalization phase.

18. The non-transitory computer-readable medium of claim 14, wherein the machine learning model comprises a multi-class neural network.

19. The non-transitory computer-readable medium of claim 14, wherein the one or more instructions, that cause the device to provide instructions for the UI, cause the device to:
input the one or more recommended parameters to a web-based graph generator.

20. The non-transitory computer-readable medium of claim 14, wherein the one or more files comprise a presentation file or a portable document format file.
